(19) United States
(12) Patent Application Publication
(10) Pub. No.: US 2014/0076229 A1
(43) Pub. Date: Mar. 20, 2014

(54) DIRECTIONAL INDICATING FIRE HOSE

(71) Applicant: Rex W. Thomas, Greenville, SC (US)

(72) Inventor: Rex W. Thomas, Greenville, SC (US)

(21) Appl. No.: 13/621,630

(22) Filed: Sep. 17, 2012

(51) Int. Cl. A62B 3/00

(52) U.S. Cl. CPC A62B 3/00
USPC 116/205

(57) ABSTRACT

An exit indicating fire hose comprising: a fire hose having an entrance coupling attached to the fire hose disposed at the end of the fire hose for receiving water; a first directional indicator attached to the fire hose having first end which indicates the direction toward the water source enters the fire hose; a second directional indicator attached to generally the opposite side of the fire hose disposed away from the first directional indicator a predetermined distance; and, wherein the first directional indicator and the second directional indicator have a height above the fire hose so that the directional indicator can indicate direction visually and through touch.

### CLAIM OF PRIORITY

The application claims priority from U.S. Provisional Patent Application 61/535,139 filed Sep. 15, 2011.

### FIELD OF THE INVENTION

This invention is directed to a fire hose having an integrated exit indicator for directional information incorporated into the fire hose, allowing firefighters in low lighting to locate a safe exit.

### BACKGROUND OF THE INVENTION

Firefighting contains many inherent dangers, especially when it is being conducted inside a burning structure or other enclosed space. In addition to the flames, heat, potential for structural collapse, large quantities of blinding smoke can quickly fill a room or the operational space of the firefighter. Under such conditions, it is easy for firefighters to become disoriented. When the firefighter becomes disoriented, he or she can fail to find an exit and become “trapped” in a room or other location within a building. Disorientation is the loss of direction firefighters experience when searching a smoke-filled room. It happens primarily when firefighters fail to use an organized search technique when moving around the smoky room and prevents firefighters from returning to the safety of the door or window of entry. Disoriented firefighters often are killed by flashover or die from asphyxiation in smoke after their SCBA run out of air. And it doesn't take a large space for disorientation to occur: the bodies of firefighters have been found next to doors and windows in 10-by-10-foot rooms that had been filled with thick smoke.

Traditionally, the firefighters that fail to maintain a grip on the fire hose, either intentionally or unintentionally, must recover the hose so that it can lead the firefighter to the water source, e.g., the exit of the structure. Recovering the hose in the smoke and potential disorientation may require the firefighter to crawl on the floor to seek out the hose by hand. Even if the firefighter regains possession of the hose, it can be difficult, if not impossible, for the firefighter to determine which direction to follow the hose to safely exit the structure. This difficulty is greatly increased where multiple hoses are employed and firefighters often encounter multiple hoses entangled. The ability to successfully use the fire hose to exit the building provides the firefighter with a critical lifeline, allowing the firefighter to fight fires as well as to guide firefighters to safe exits.

Several attempts have been made to provide for indicators for determining direction of an exit by following the fire hose. For example, U.S. Pat. No. 7,942,544 discloses an indicating device for mounting on a hose including a body having an outer wall and defining a central passage extending axially through the body between a first end and a second end, and a plurality of lights arranged around the annular body so as to be visible from beyond the outer wall. The lights can illuminate the fire hose in the dark and can indicate the exit. However, these devices can be improperly arranged to point in the wrong direction, do not provide for a tactile indication of direction, must be added to the fire hose after the fact, do not allow the fire hose to be rolled for storage efficiently, and other disadvantages.

U.S. Pat. No. 4,844,000 is directed to an indicating clamp for attachment to firefighting hoses which indicate direction to exit the building. The disadvantage with this invention is that it must be placed on the fire hose and can be put on backwards and improperly spaced along the fire hose so that this invention, improperly installed, can be more dangerous than if it had not been installed at all. U.S. Patent D345,519 is a directional indicating band for attachment to firefighting hose sharing the same dangerous disadvantages.

U.S. Pat. No. 5,027,741 discloses a stripe repetitively painted, coated, or otherwise attached to the outer surface of the fire hose. The stripe tapers from wide to narrow in the general direction of the first end of the fire hose, thereby indicating that water and safety lie in that direction. In order for the stripe to be visible under dark and smoky conditions, the stripe is made from a luminous material or luminous paint. By “luminous” is meant that the material or paint glows in the dark; a variety of such materials are known, some of which are fluorescent and some of which are phosphorescent. However, this invention does not provide a tactile indicator and requires light for the paint to glow in the dark. Such paint loses luminance over time and even when fully illuminating, the paint can be difficult, if not impossible, to see in a heavy smoke-filled room.

U.S. Pat. Nos. 6,766,761 and 5,623,890 disclose indicator devices captured between couplings at the end of fire hose sections that point to the source of the fire hose and to safety. However, fire hoses typically have a length of 100 feet. Placing indicators every 50-100 feet at the couplings simply does not provide the needed directional indicators sufficient to assist a firefighter. Obviously, 50-100 feet of fire hose could cover several rooms and would require the firefighter to further penetrate a dangerous structure just to find out that the firefighter was going the wrong way.

### SUMMARY OF THE INVENTION

The objects of the invention are accomplished by providing an exit indicating fire hose comprising: a fire hose having an entrance coupling attached to the fire hose disposed at the end of the fire hose for receiving water; a first directional indicator attached to the fire hose having first end which indicates the direction toward the water source enters the fire hose; a second directional indicator attached to generally the opposite side of the fire hose disposed away from the first directional indicator a predetermined distance; and, wherein the first directional indicator and the second directional indicator have a height above the fire hose so that the directional indicator can indicate direction visually and through touch.

The directional indicator can include a reflective surface and can be made from the same material as the fire hose. The first directional indicator can be attached through a method taken from the group consisting of: attaching the directional indicator during the manufacturing process; attaching the directional indicator post-manufacturing process; attaching the directional indicator using an adhesive and attaching the directional indicator through hot press.

The directional indicator can have a thickness of approximately ⅛ inches, a length in the range of 2½ and 4½ inches, and a width in the range of 1½ and 2½ inches. The distal end to the first end of the directional indicator is constructed to have a shape taken from the group consisting of: flat, concave, and convex.

The invention can also include a direction indicating fire hose comprising: a fire hose having a first coupling disposed at a proximal end and a second coupling disposed at a distal end; a plurality of directional indicators carried by the hose and disposed at pre-determined distances between the first and the second couplings, wherein the directional indicators are raised above an outer diameter of the fire hose; and, whereas an direction is indicated to an individual through the individual's visual and tactile senses. The hose can have the directional indicators spaced less than three feet or less than two feet or less than one foot apart. The directional indicator can be triangular shape. The surface of the directional indicator can include a reflective surface disposed the surface of the directional indicator facing away from the hose.

The directional indicator can be attached to the top the fire hose through a method taken from the group consisting of: attaching the directional indicator during the manufacturing process; attaching the directional indicator post-manufacturing process; attaching the directional indicator using an adhesive and attaching the directional indicator through hot press. The directional indicator can have a thickness of approximately ⅛ inches, a length in the range of 2½ and 4½ inches, and a width in the range of 1½ and 2½ inches on one embodiment. In one embodiment the directional indicator is sized wherein at least one of these dimensions is larger than these dimensions. The hose can include a covering attached to the hose and covering at least one discretional indicator.

In one embodiment, the hose can include a sleeve disposed between the first and the second coupling surrounding the hose wherein the direction indicator is carried by the sleeve. A pocket can be included and defined in the sleeve for receiving the directional indicator. The pocket and the direction indicator can be operatively associated so that the direction indicator may only be inserted in a predetermined direction into the pocket.

The directional indicators can be arranged diametrically opposed to one another in an alternating arrangement along a longitudinal axis of the hose. The invention can include a direction indicating fire hose having a first coupling attached at a proximal end of the fire hose and a second coupling attached to a distal end of the fire hose comprising: a plurality of raised directional indicators attached to the fire hose having a head visually and tactically indicating a direction and a tail visually and tactically indicating an opposite direction, wherein the directional indicators are arranged at predetermined distances between the first and the second couplings.

The directional indicators can point to a direction taken from the group consisting of: an exit to a room, an exit to a building, a water source attached to the hose and a male coupling attached to the fire hose.

The directional indicators include: a flat position wherein the directional indicator is generally flat and disposed along a flat side of a lay-flat fire hose when the fire hose is in a stored position; and, a curved position wherein the directional indicator is curved to contour to the generally round cross-section of a charged fire hose when the fire hose is charged with fluid.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a perspective view of the invention;

FIG. 2 is a perspective view of the invention;

FIGS. 3A and 3B are perspectives views of the invention;

FIG. 3C is a cross-section view of the invention;

FIG. 4 is a perspective view of the invention;

FIG. 5 is a perspective view of aspects of the invention;

FIGS. 6A and 6B are perspective views of the invention;

FIGS. 7A and 7B are perspective views of aspects of the invention; and,

FIGS. 8 is a perspective view of the invention.

### DESCRIPTION OF A PREFERRED EMBODIMENT

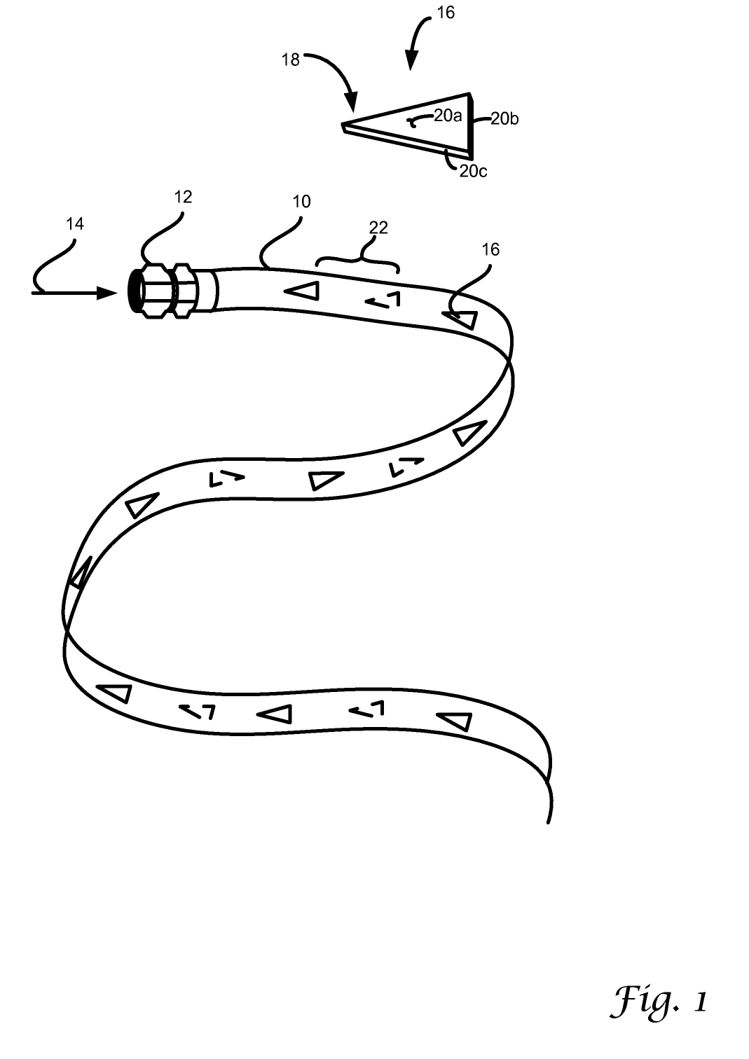

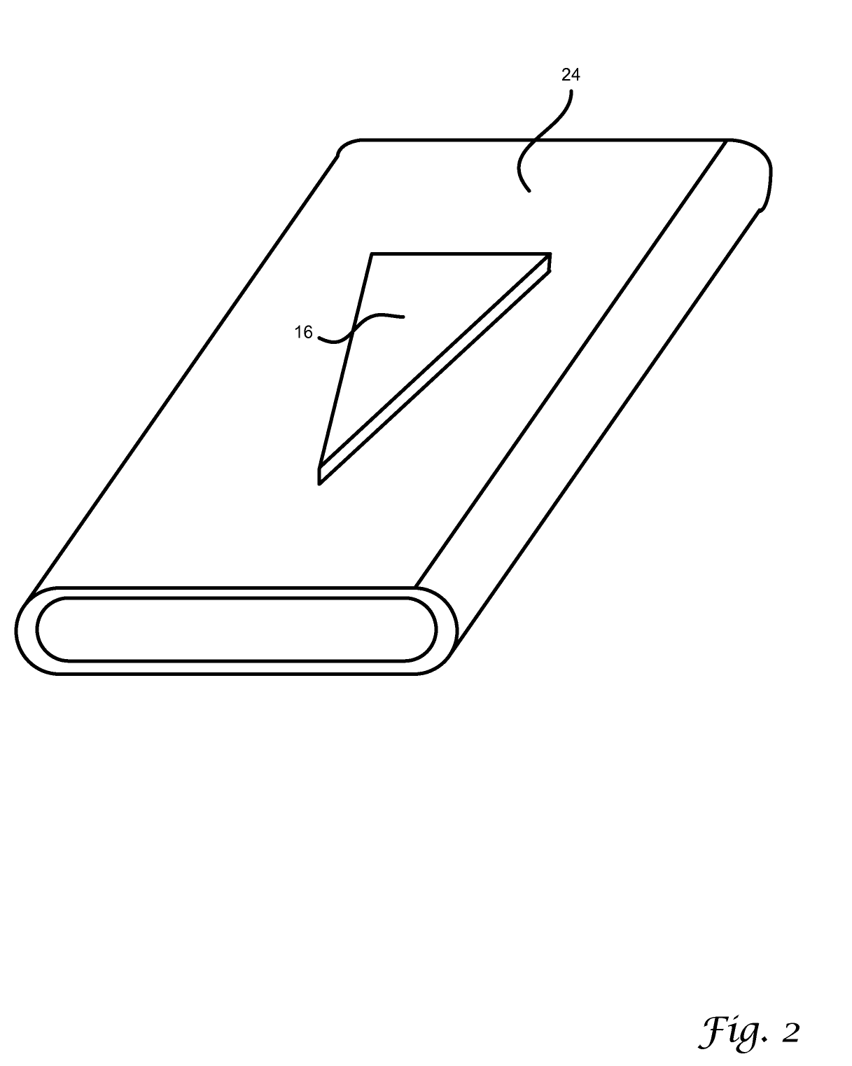

Referring to FIG. 1, a fire hose 10, an entrance coupling (first coupling) 12 is attached at a proximal end of the fire hose which is generally attached to a water source. Typically, this coupling is a male coupling. A second coupling can be attached to the distal end of the fire hose. Typically, this coupling is a female coupling. The water source is generally outside the structure containing the fire and is in a relatively safe place for the firefighter. The normal water flow is shown as 14 into the fire hose. Typically, a fire hose collapses into a flat orientation for storage; typically by rolling up the fire hose. Directional indicators 16 are triangular in shape and attached directly to the hose. Directional indicator has a first end (or head) 18 which indicates the direction toward a water source, an exit to a room, an exit to a structure or other direction. The directional indicator is flexible and three-dimensional and in one embodiment, made from the same or similar material as the fire hose itself. The directional indicator can include a top portion 20a, rear portion (or tail) 20b, height 20c and a bottom portion (not shown). In one embodiment, the direction is toward the mail coupling which coincides with the water source if the male coupling is ultimately attached to a water source. Generally, the male coupling is used to attach a hose to a water source. In one embodiment, the directional indicator is placed on the flat portion of the fire hose when the fire hose is in the stored position, i.e. when the fire hose is not charged at shown in FIG. 2.

In one embodiment, the thickness of the directional indicator is approximately ¼ inches, the length is in the range of 2½ and 4½ inches, and the width is in the range of 1½ and 2½ inches. In one embodiment, the directional indicators include a reflective surface which is attached to the top surface of the directional indicator, coated or integrated into the surface such as with microstructures machined into the directional indicator during or after manufacturing.

When attached to the fire hose, the directional indicators are placed at a predetermined distance 22 on opposite side of the fire hose. In one embodiment, the distance is 2½ feet. Preferably, the directional indicators are attached on planar side of the fire hose when the fire hose is in the collapsed configuration as shown in FIG. 2. Planar side is the generally flat side when the fire hose is in its collapsed position such as when it is emptied of water or rolled for storage.

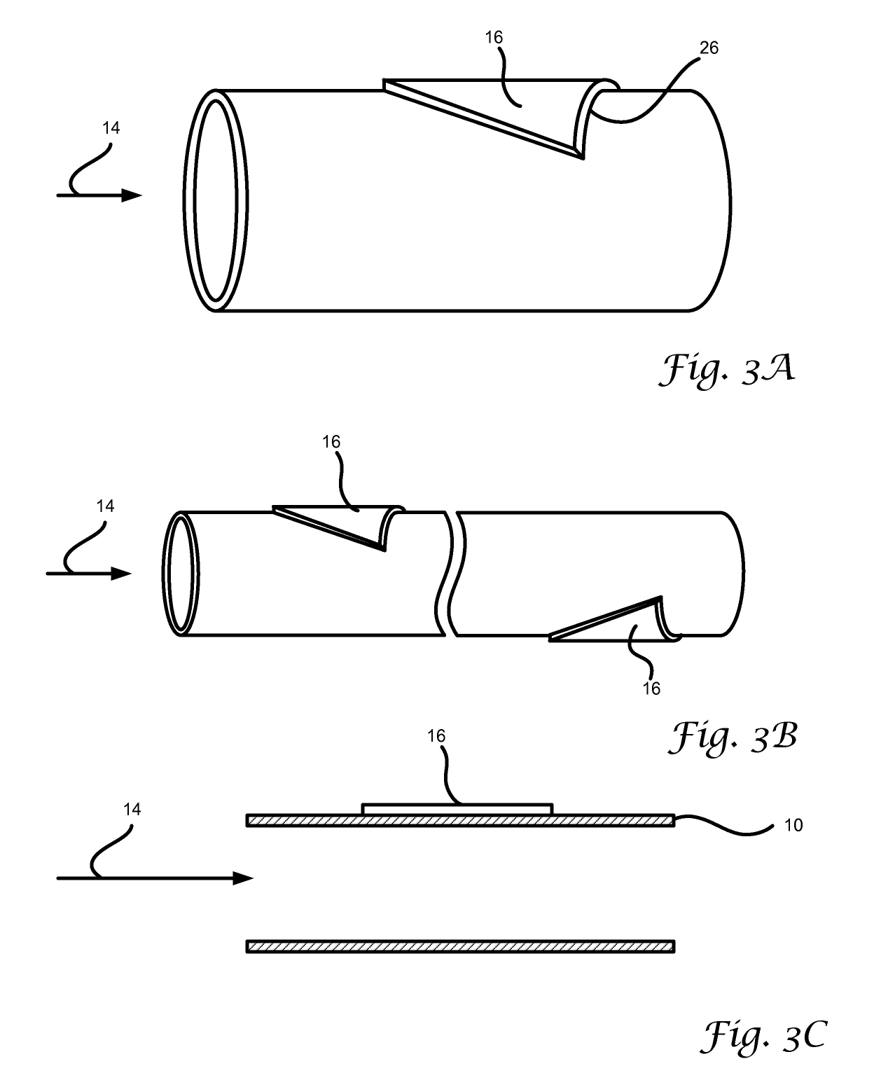

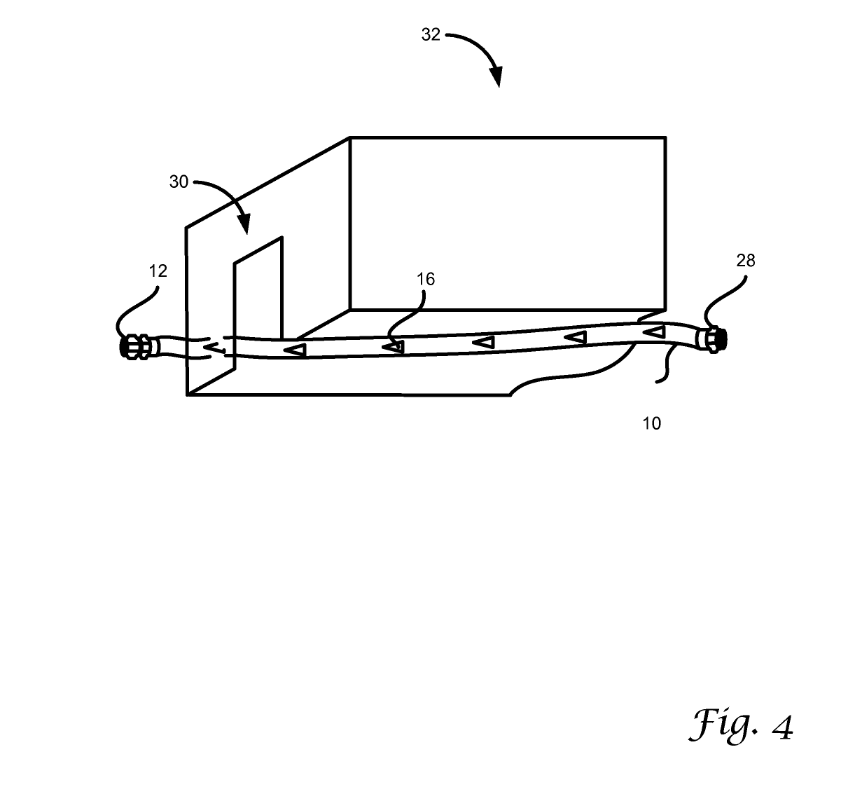

Referring to FIG. 3A, the directional indicator takes a curved shape 26 when the fire hose is filled with water (charged) and in its operational arrangement. The indicator protrudes above the surface of the fire hose and provides for a tactile as well as visible indicator toward the water source. The directional indicator is of a sufficient height so that it can be felt through the firefighters' equipment, including the firefighters' gloves. Referring to FIG. 3B, the directional indicators can be placed diametrically opposed to each other in an alternating arrangement providing for the directional indicators to be used regardless of the orientation of the fire hose in relation to an top or bottom. FIG. 3C shown a cross section of the hose and the raised arrangement of the directional indicator. In use, as shown in FIG. 4, the fire hose provides for a means allowing the firefighter to follow the directional indicators and to exit the structure.

Referring to FIG. 4, the directional indicators would point to entrance coupling 14 and away from exit coupling 28 when the fire hose 10 is in room 32. The directional indicators would point against the normal flow direction of the water in the hose.

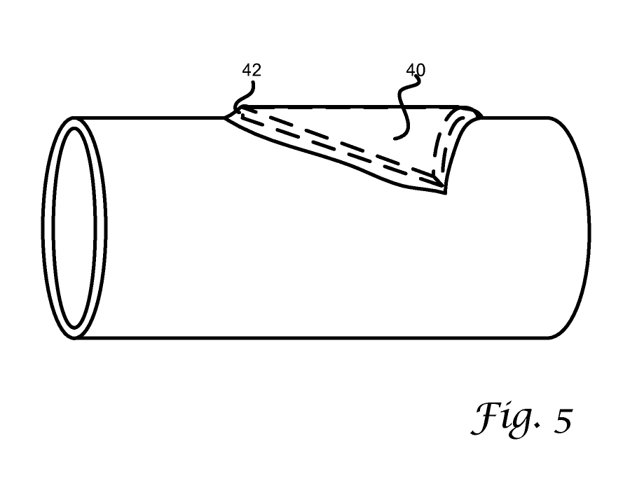

Referring to FIG. 5, in one embodiment, the directional indicator can include an insert 40 having a three-dimensional shape. The insert can be contained in a cloth or flexible covering 42 so that for cloth or other similar fire hose manufacturing material, the directional insert is attached to the fire hose through sewing the directional insert onto the hose or by inserting the directional insert into pockets defined by the flexible covering 42.

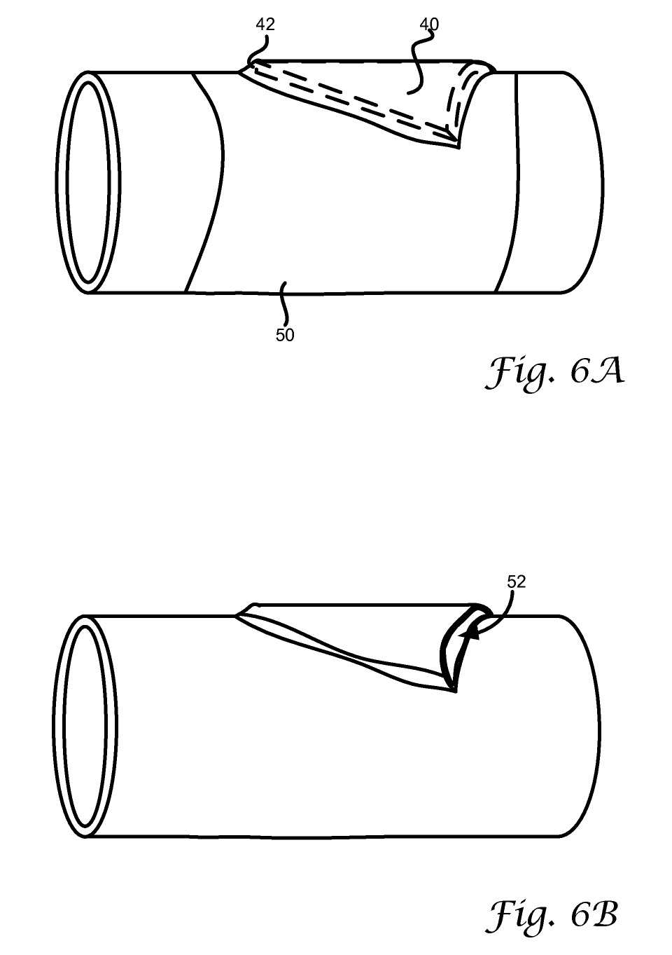

Referring to FIG. 6A, another embodiment is shown wherein flexible sleeves can surround the fire hose wherein each sleeve includes at least one directional indicator. In this embodiment, sleeve 50, having indicator 16, can be placed on an existing fire hose providing the benefits of the invention to n existing fire hose. The sleeve can be elastic allowing the sleeve to clear the fire hose couplings attached to the ends of the hose and still fit securely around the hose itself. Referring to FIG. 6B, a pocket 52 can be include with the fire hose for receiving a directional indicator. The pocket can be configured so that the directional indicator will only enter the pocket is one direction so that the head of the directional indicator points toward the exit, water source, of other desired direction.

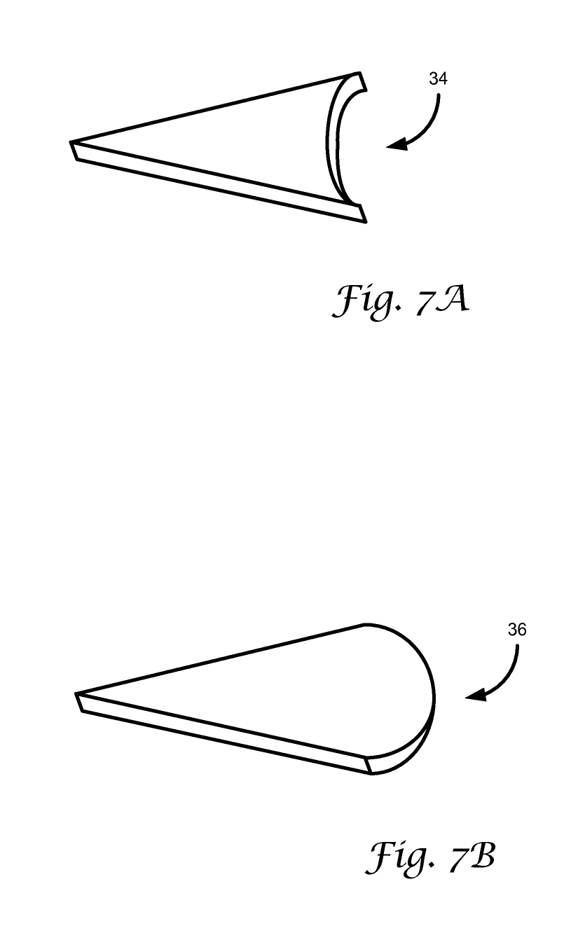

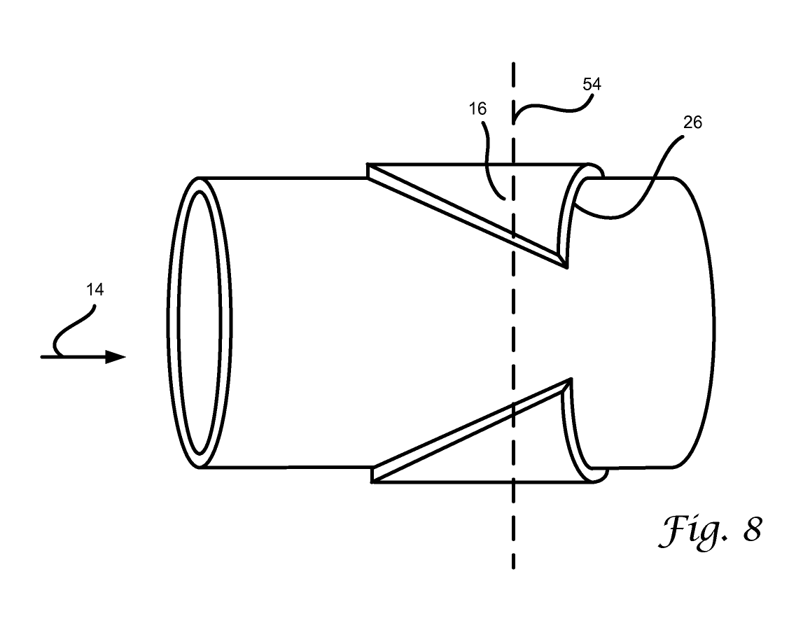

Referring to FIGS. 7A and 7B, the directional indicator can have the generally planar surface in the distal end or can have a concave shape as shown as 34 of a convex shape as shown as 36. Referring to FIG. 8, the directional indicators can be arranged so that a plurality of directional indicators surround the hose along a diameter 54 so that the plurality of directional indicators can indicate direction regardless of the hose orientation as the hose rotated about its axis. The plurality of directional indicators surrounding the hose can be at predetermined intervals between the first and second coupling.

The directional indicators can be manufactured into the fire hose when it is made by molding. The directional indicators can also be applied after the fire hose has been manufactured through means such as using a hot press, glue or other adhesive, stamping, rolling or otherwise affixing the directional indicators to the fire hose. With directional indicators placed on generally opposite sides of the fire hose, the firefighter can, regardless of the orientation of the fire hose, use the directional indicator (by sight or tactile sensation), to seek an exit 30.

While a preferred embodiment of the invention has been described using specific terms, such description is for illustrative purposes only, and it is to be understood that changes and variations may be made without departing from the spirit or scope of the following claims.

What is claimed is:

1. An direction indicating fire hose comprising:
a fire hose having a first coupling disposed at a proximal end and a second coupling disposed at a distal end;
a plurality of directional indicators carried by said hose and disposed at pre-determined distances between said first and said second couplings, wherein said directional indicators are raised above an outer diameter of said fire hose; and,
whereas an direction is indicated to an individual through said individual's visual and tactile senses.

2. The hose of claim 1 wherein said pre-determined distances are less then three feet.

3. The hose of claim 1 wherein said directional indicator is a triangular shape.

4. The hose of claim 1 including a reflective surface disposed the surface of said directional indicator facing away from said hose.

5. The hose of claim 1 wherein at least one directional indicator is attached top said fire hose through a method taken from the group consisting of: attaching said directional indicator during the manufacturing process; attaching said directional indicator post-manufacturing process; attaching said directional indicator using an adhesive and attaching said directional indicator through hot press.

6. The fire hose of claim 1 wherein said directional indicator has a thickness of approximately ⅛ inches, a length in the range of 2½ and 4½ inches, and a width in the range of 1½ and 2½ inches.

7. The hose of claim 1 wherein at least one directional indicator includes a side having a shape taken from the group consisting of: flat, concave, and convex.

8. The hose of claim 1 including a covering attached to said hose and covering at least one discretional indicator.

9. The hose of claim 1 including a sleeve disposed between said first and said second coupling surrounding said hose wherein said direction indicator is carried by said sleeve.

10. The hose of claim 9 including a pocket defined in said sleeve for receiving said directional indicator.

11. The hose of claim 10 wherein said pocket and said direction indicator are operatively associated so that said direction indicator may only be inserted in a predetermined direction into said pocket.

12. An direction indicating apparatus cooperatively associated with a fire hose, wherein said fire hose includes a first coupling attached at a proximal end of the fire hose and a second coupling attached to a distal end of the fire hose comprising:
a plurality of directional indicators carried by said fire hose and disposed at pre-determined distances between said first and said second couplings and disposed circumventially around said fire hose,
a head included in said directional indicator for indicating a direction;
a tail included in said directional indicator indicating an opposite direction; and,
whereas a direction is indicated to an individual through said individual's visual and tactile senses.

13. The hose of claim 12 wherein said directional indicators has a height above the outer surface of said hose of at least ⅛ inch.

14. The hose of claim 12 including a pocket carried by said hose for receiving at least one directional indicator.

15. The hose of claim 12 wherein said directional indicators are arranged diametrically opposed to one another in an alternating arrangement along a longitudinal axis of said hose.

16. An direction indicating fire hose having a first coupling attached at a proximal end of the fire hose and a second coupling attached to a distal end of the fire hose comprising: a plurality of raised directional indicators attached to said fire hose having a head visually and tactically indicating a direction and a tail visually and tactically indicating an opposite direction, wherein said directional indicators are arranged at predetermined distances between said first and said second couplings.

17. The hose of claim 16 wherein said directional indicators point to a direction taken from the group consisting of: an exit to a room, an exit to a building, a water source attached to said hose and a male coupling attached to said fire hose.

18. The hose of claim 16 wherein said directional indicators include:
a flat position wherein said directional indicator is generally flat and disposed along a flat side of a lay-flat fire hose when said fire hose is in a stored position; and,
a curved position wherein said directional indicator is curved to contour to the generally round cross-section of a charged fire hose when said fire hose is charged with fluid.

19. The hose of claim 18 including a plurality of pockets carried by said fire hose for receiving said directional indicators so that each directional indicator points in the same direction along a longitudinal axis of said fire hose.

20. The hose of claim 18 wherein said directional indicators are arranged in sets of directional indicators surrounding said hose along a diameter and said sets of directional indicators are arranged in an alternating diametrically opposed configuration.
